(19) United States
(12) Patent Application Publication
(10) Pub. No.: US 2011/0014443 A1
(43) Pub. Date: Jan. 20, 2011

(54) ADHESIVE TAPE FOR ELECTRONIC COMPONENT FABRICATION

(75) Inventors: Hirotoki Yokoi, Hiratsuka-shi (JP); Akira Suda, Hiratsuka-shi (JP); Syouzou Yano, Chigasaki-shi (JP); Shinichi Ishiwata, Isehara-shi (JP)

Correspondence Address: OLIFF & BERRIDGE, PLC, P.O. BOX 320850, ALEXANDRIA, VA, 22320-4850, US

(73) Assignee: The Furukawa Electric Co., Ltd, Tokyo (JP)

(21) Appl. No.: 12/921,441

(22) PCT Filed: Dec. 10, 2008
(86) PCT No.: PCT/JP2008/072406

§ 371 Date: Sep. 8, 2010

(30) Foreign Application Priority Data
Mar. 10, 2008 (JP) 2008-059316

(51) Int. Cl. C09J 7/02; B32B 7/02; B32B 27/30

(52) U.S. Cl. 428/216; 428/355 EN; 428/354; 428/336

(57) ABSTRACT

Problem to be Solved by the Invention: To provide a adhesive tape for electronic component fabrication, having extremely high antistatic performance, superior adherence between an antistatic layer and a adhesive layer, does not cause corrosion of a magnetic head that is comprised of a metal such as pure copper or the like, and alumina to occur, and which is easier to be released again.

Means for Solving the Problem: The provided adhesive tape for electronic component fabrication in accordance with the present invention comprises: a base material film (3); and a adhesive layer (7), wherein an antistatic layer (5) which is comprised of an electrically conductive polymer is formed on one side or both sides of the base material film (3), the adhesive layer (7) is a radiation curable type, which has a copolymer of an acrylic system as a principal ingredient, each containing at least a radiation curable carbon-carbon double bond containing group, a hydroxyl group and a carbonyl group, that are individually attached to a principal chain, and which has a gel fraction higher than or equal to sixty percent.

### TECHNICAL FIELD

The present invention relates to a adhesive tape for electronic component fabrication which has a superior antistatic performance and which does not cause corrosion when in contact with a metal surface, and more specifically to a adhesive tape which is used when producing a component of a hard disk.

### BACKGROUND ART

A adhesive tape has been known to fix or protect a component in a process being performed such as a polishing process, a splitting process, and other processes when producing a component for a hard disk, an electrical or electronic component, a semiconductor component and the like. As examples of the adhesive tape described above, there are the following: a adhesive tape with a adhesive layer of a removable acrylic system provided on a base material film, and a adhesive tape provided with a adhesive layer of photo crosslinking type, that is strongly resistive against external force when applied, but can be removed by a small force at a time of removal. Such adhesive tape is removed when a predetermined processing line is finished, however, a static electrical charge is generated between the component and the adhesive tape at the time of removal, which is called a stripping charge. In order to suppress any negative effect to an adherend (such as a circuit or the like) due to this static electrical charge, the following are used: (a) a adhesive tape in which antistatic treatment is performed for a back side face of a base material film; (b) a adhesive tape in which an antistatic intermediate layer is prepared between a base material film and a adhesive layer (refer to the following Patent Document 1 for example); and (c) a adhesive tape in which an antistatic agent is added and mixed into a adhesive layer (refer to the following Patent Documents 2, 3, 4 for example).

[Patent Document 1] Japanese Patent Application Publication No. 2004-189769

[Patent Document 2] Japanese Patent Application Publication No. 2002-211677

[Patent Document 3] Japanese Patent Application Publication No. 2005-314476

[Patent Document 4] Japanese Patent Application Publication No. 2006-152235

### DISCLOSURE OF THE INVENTION

### Problems to be Solved by the Invention

However, when an insulating material, such as a ceramic, glass or the like, is used as a substrate of a component on which a circuit is to be formed, the amount of generated static electrical charge is large and it takes time for this generated static electrical charge to be attenuated. For such a component, it is not possible to obtain a sufficient antistatic effect even though the adhesive tape is applied, and there is a high risk that the circuit will break down. Therefore in actual practice, a static eliminator, such as an ionizer or the like, is additionally used in the production process of the component.

However, it is not possible to obtain a sufficient antistatic effect by making use of the countermeasure mentioned above. Further, productivity is poor, and the protection of the adherend is not sufficient.

As in (b) described above, a adhesive tape for fixing a semiconductor is disclosed by which it is possible to provide an antistatic function without problems occurring such as contamination to the adherend due to the adhesive, or a decrease in reliability due to change over time of physical properties of the adhesive or the like, by providing an antistatic layer which contains a charge transfer type boron polymer and which has a complex structure of a nitrogen atom and a boron atom between the base material film and the adhesive layer. With this tape, it becomes possible to obtain a predetermined effect. However, the antistatic performance changes largely due to humidity, and in some cases the adherence between the base material film and the antistatic layer may become a problem. Therefore an improvement is desired.

Performing treatment of the adhesive layer side and not the base material film side in order to prevent the adhesive tape from generating the charge associated with peeling is also considered to be effective. However, as in (c) described above, the physical properties of the adhesive cannot help but change when a material which has an antistatic effect, such as a surface active agent, an electrically conductive filler, carbon black, or the like, is added into the adhesive itself. It becomes difficult to control or suppress the physical properties of the adhesive or the change thereof over time. Moreover, when removing the adhesive tape there is an apprehension of whether the adhesive or the added antistatic material itself migrates to the adherend causing the adherend to become contaminated. In such a case, matter such as visible remaining glue, an adhesion of particle shaped microscopic matter, an adhesion of a liquid which is not optically observable, or the like may occur on a surface of the adherend. Such matter becomes the cause of negative effects in a following process, such as adhesive failure of a component or the like.

Furthermore, higher antistatic performance is required for processing a magnetic head of a hard disk, compared with ordinary processing of a semiconductor. Moreover, extremely thin metal layers of pure copper or the like are superposed in the magnetic head, and it is easy for the same to become excessively corroded. Therefore a higher corrosion resistance is required for the tape. As a method to solve the corrosion and electrostatic break down at the same time, the use of ionic liquid and the antistatic agent of the metal salt system, as described above. Trying the above can provide higher corrosion resistance of general electronic components, however, it is essential for the magnetic head to reduce the ionic substance as much as possible, because the magnetic head is easily corroded. A halogenous ion is disliked in particular among the ionic impurities. The defective proportion has been reduced so far by decreasing this halogenous ion as much as possible. However, as the performance of the magnetic head becomes higher, the corrosion is caused to occur due to a functional group of a polymer chain, which is a principal ingredient of the adhesive. Corrosion is not sufficiently prevented by only reducing the halogenous ions.

Therefore, taking the problems mentioned above into consideration, the objective of the present invention is to provide a adhesive tape for electronic component fabrication, by which it becomes possible to reduce the contamination of the adherend and the change over time of the physical properties of the adhesive, in order to obtain higher antistatic performance without causing corrosion to occur even when processing the magnetic head, which is a component of the hard disk.

### Means for Solving the Problem

Here the inventors of the present invention have studied intensively in order to attain the aforementioned objective. As a result, it was found that it becomes possible to solve the problems of corrosion and electrostatic break down at the same time, by making use of adhesive tape which comprises a base material film and a adhesive layer, wherein an antistatic layer is formed on one side or on both sides of the base material film, the adhesive layer having a copolymer of acrylic system as a principal ingredient, each containing at least a radiation curable carbon-carbon double bond containing group, a hydroxyl group and a carbonyl group, that are individually attached to a principal chain, with the proportion of the radiation curable carbon-carbon double bond containing group on the principal chain in the copolymer of an acrylic system being within a range from 0.5 meq/g to 2.0 meq/g, the proportion of the hydroxyl group on the principal chain in the copolymer of an acrylic system being within a range from 0.1 mgKOH/g to 60 mgKOH/g, the proportion of the carbonyl group on the principal chain in the copolymer of an acrylic system being within a range from 0.5 mgKOH/g to 10 mgKOH/g, and a gel fraction of the copolymer of an acrylic system being higher than or equal to 60 percent. It becomes possible to realize the present invention based on this knowledge.

That is to say, in accordance with the present invention the following are to be provided:

(1) A adhesive tape for electronic component fabrication in order to stick and mount an electronic component which contains metal or alumina, comprising: a base material; and a adhesive layer which is formed on one side of the base material, wherein the adhesive layer has a copolymer of an acrylic system as a principal ingredient, each having a group which contains at least a radiation curable carbon-carbon double bond containing group, a hydroxyl group and a carbonyl group, that are individually attached to a principal chain, with the proportion of the radiation curable carbon-carbon double bond containing group on the principal chain in the copolymer of an acrylic system being within a range from 0.5 meq/g to 2.0 meq/g, the proportion of the hydroxyl group on the principal chain in the copolymer of an acrylic system being within a range from 0.1 mgKOH/g to 60 mgKOH/g, the proportion of the carbonyl group on the principal chain in the copolymer of an acrylic system being within a range from 0.5 mgKOH/g to 10 mgKOH/g, and the gel fraction of the copolymer of an acrylic system being higher than or equal to sixty percent.

(2) The adhesive tape for electronic component fabrication according to item (1), wherein the base material comprises an antistatic layer which is formed on both sides or one side thereof.

(3) The adhesive tape for electronic component fabrication according to item (1) or item (2), wherein the antistatic layer is a polymer of a pi-electron conjugated system, or further preferably a polymer of a polypyrrole system or a polymer of a polythiophene system.

(4) The adhesive tape for electronic component fabrication according to item (1) to item (3), wherein the thickness of the antistatic layer is within a range from 0.001 μm to 2.0 μm.

(5) The adhesive tape for electronic component fabrication according to item (1) to item (4), wherein a thickness of the adhesive layer is within a range from 1 μm to 70 μm.

Here in accordance with the present specification “as a principal ingredient” means that the principal ingredient of the adhesive constituent of the adhesive layer, which is comprised of an adhesive constituent, a curing agent and a polymerization initiator, is a copolymer of an acrylic system, where each contains a group containing a carbon-carbon double bond, a hydroxyl group and a carbonyl group. Moreover, the adhesive tape in accordance with the present invention is comprised of the adhesive layer of which sixty percent by weight or greater is comprised of the copolymer of an acrylic system, where each contains the group containing the carbon-carbon double bond, the hydroxyl group and the carbonyl group.

### Effects of the Invention

The adhesive tape in accordance with the present invention has a very high antistatic performance. Moreover, the adhesive tape does not cause corrosion of a magnetic head which is formed of metal, such as pure copper or the like, and alumina. Further, the adhesive tape has superior adherence between the antistatic layer and the adhesive layer. Therefore less negative effect on the adherend even in dicing or back grinding treatment or the like of a semiconductor component. The adhesive tape can be used in a wider range of fields. Still further, the adhesive tape is effective in preventing a decrease in production yield rate of a semiconductor product. Furthermore, the adhesive tape can be easily removed, because the radiation curable polymer is adopted for the adhesive layer.

### BRIEF DESCRIPTION OF THE DRAWINGS

FIG. 1 is a drawing showing a adhesive tape (1) in accordance with an embodiment.

FIG. 2 is a drawing showing a measuring method of adherence between an antistatic layer and a adhesive layer in accordance with an embodiment.

### BRIEF DESCRIPTION OF THE REFERENCE SYMBOLS

1. ADHESIVE TAPE

3. BASE MATERIAL FILM

5. ANTISTATIC LAYER

7. ADHESIVE LAYER

9. RELEASE LINER

11. NOTCH

13. FRAME

15. ADHESIVE TAPE

### BEST MODE FOR CARRYING OUT THE INVENTION

Embodiments in accordance with the present invention will be described in detail below with reference to the drawings.

A adhesive tape (1) in accordance with the present embodiment will be described in detail below.

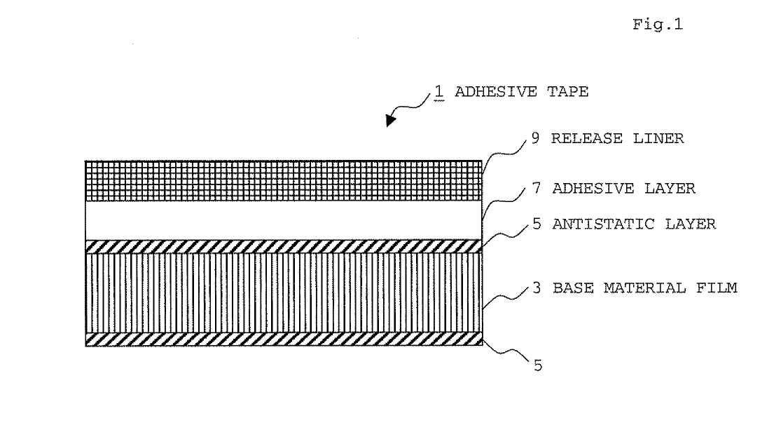

FIG. 1 is a schematic view for showing a cross section of the adhesive tape (1). An antistatic layer (5) is formed on both sides of a base material film (3), and a adhesive layer (7) is formed on one of the antistatic layers (5). Moreover, a release liner (9) is formed on the adhesive layer (7).

The main purpose of the base material film (3) is to protect the semiconductor from shock during the period of processing. It is important in particular for the base material film (3) to have a water resisting property against aqueous cleaning or the like, and to have a holding property of a workpiece. Accordingly, it is desirable for the base material film (3) to be formed of a polymer material, such as a polyolefin of polyethylene, polypropylene, polybutene, or the like, an ethylene copolymer such as a copolymer of ethylene and vinyl acetate, a copolymer of ethylene and (meth)acrylic acid, a copolymer of ethylene and (meth)acrylic ester, or the like, a soft polyvinyl chloride, a polyethylene terephthalate, a polyethylene naphthalate, a semi hard polyvinyl chloride, a polyester, a polyurethane, a polyamide, a polyimide, natural rubber, a synthetic rubber, or the like. Such a material is used in the form of a single layer film or a multiple layered film, respectively.

Moreover, it is desirable for the base material film (3) to have visible light transparency and to have ultraviolet light transparency as well. Further, the thickness of the base material film (3) is not limited in particular. However, the thickness of the base material is preferably within a range from 10 to 500 μm, more preferably within a range from 40 to 500 μm, and preferably in particular within a range from 80 to 250 μm.

Here, the antistatic layer (5) is formed of an electrically conductive polymer. From the point of view of antistatic performance, it is desirable that the electrically conductive polymer which is used for the antistatic layers (5) be made of a polymer of a pi-electron conjugated system which is formed by performing polymerization of a monomer that has a conjugated double bond in a molecular structure. From the point of view of both temporal stability of the antistatic effect and excellent non-polluted property in particular, it is desirable that a polymer of a polypyrrole system and of a polymer of a polythiophene system be used as the polymer of a pi-electron conjugated system. It is further preferable for the same to be the antistatic layer for which the polymer of polypyrrole system is used.

As a method of providing the antistatic layer (5), there are following methods, i.e., a method of forming a film layer by making use of a coating (such as a gravure coating or the like), a method in which a monomer is contacted with a surface of a base material film and then polymerized under the existence of an oxidizing agent (an immersion polymerization method), and the like. In the immersion polymerization method, an electrically conductive polymer layer is formed by immersing a base material film into a solution of which a dopant such as an inorganic acid, an organo sulfonic acid, or the like and an oxidation polymerization agent are added corresponding to the electrical conductivity into a monomer such as a pyrrole or a thiophene or a derivative of those or the like, thus performing the polymerization of the monomer, and then causing a precipitation of the electrically conductive polymer directly on to the surface of the base material film to form an electrically conductive polymer layer, as disclosed in the Japanese Patent Application Publication No. Show 62 (1987)-275173. Moreover, as a method of forming the antistatic layer (5), it is desirable to form a polymer of the pi-electron conjugated system by making use of the immersion polymerization method.

In the immersion polymerization method, the antistatic treatment is performed directly on the surface of the base material film (3) so that the antistatic effect can be obtained without making use of any binder at all. Accordingly, it becomes possible to prevent a bleed out of a constituent having a lower molecular weight and of an ionic impurity from the base material film (3) to the adhesive layer (7), thus a metal is not corroded at all.

As described in further detail below, it becomes possible to form the antistatic layer (5) to be an extremely thin film by making use of the immersion polymerization method. Moreover, in accordance with the above mentioned immersion polymerization method, it is possible to perform the polymerization selectively on only a concave part of the surface of a concave and convex face of the base material film (3). Therefore it becomes possible to perform the antistatic treatment without changing the state of the face of the surface of the base material film (3). Thus, it becomes possible to obtain extremely superior adherence between the base material film (3) for which the antistatic treatment is performed and the adhesive layer (7).

Regarding the layer thickness of the antistatic layer (5), it is necessary to be at least 0.001 μm or thicker in order for the antistatic performance to function effectively. On the contrary, the antistatic performance is not sufficient in a case where the layer thickness of the antistatic layer (5) is thinner than or equal to 0.001 μm. Therefore it is desirable for the antistatic layer (5) to have a layer thickness that is thicker than or equal to 0.001 μm. However in a case where the layer thickness is excessively thick, the antistatic layer (5) negatively affects performance during processing of dicing or pick-up of a wafer, thus the same becomes a cause of a trouble. Therefore it is desirable for the layer thickness to be thinner than or equal to 2.0 μm. Moreover, by taking into consideration the antistatic performance, the adherence between the base material and the adhesive, the effect to the tape, or the like, it is further preferable for the layer thickness to be within a range from 0.01 μm to 0.5 μm.

It is desirable for the antistatic layer (5) to be a polymer of a pi-electron conjugated system. It is also particularly desirable for the antistatic layer (5) to be a polymer of a polythiophene system in a case where transparency is required for recognition of a scribe line or the like during the dicing process or the like in particular. Moreover, it is particularly desirable for the antistatic layer (5) to be a polymer of a polypyrrole system in a case where even higher antistatic performance and nonpolluting property are required at the same time.

As a method of forming the antistatic layer which is to be formed of the polymer of a polypyrrole system, there is the method by which the monomer is brought into contact with the surface of the base material film and then polymerized under the existence of an oxidizing agent (the immersion polymerization method). More specifically, it is possible to give an example of the method of forming the electrically conductive polymer layer by immersing the base material film into a solution of which a dopant such as an inorganic acid, organo sulfonic acid, or the like, and an oxidizing agent are added into the above mentioned monomer corresponding to the electrical conductivity in order to perform the polymerization of the monomer, and then by performing precipitation of the electrically conductive polymer directly on to the surface of the base material film, as disclosed in the Japanese Patent Application Publication No. S62-275173 for example. It becomes possible to prevent the shift (bleed out) of the organic impurity or of the ionic impurity to the adhesive layer by performing the immersion polymerization of the electrically conductive polymer on to the surface of the base material film in such a manner. The same also has a superior nonpolluting property. Here, it is possible to give an example of a commercial product, such as the ST POLY (which is produced by ACHILLES CORPORATION).

Regarding the surface specific resistance of the antistatic layer (5), it is desirable to be within a range from 1×10³Ω/□ to 1×10¹³Ω/□. Or, it is preferable for the surface specific resistance to be within a range from 1×10³Ω/□, and it is further preferable for the surface specific resistance to be within a range from 1×10⁴Ω/□ to 1×10⁸Ω/□ in particular.

Next, it is possible to obtain the adhesive layer (7) by coating or drying after the coating of a solution on to the antistatic layer (5), of which an acrylic adhesive as a radiation curable type or a polymer thereof is dissolved in a solvent.

The adhesive layer (7) has a copolymer of an acrylic system as a principal ingredient, each of that having a group which contains at least a radiation curable carbon-carbon double bond containing group, a hydroxyl group and a carbonyl group, that are individually attached to a principal chain (hereinafter it is called as an “acrylic copolymer (A)”). It may be possible for an acrylic copolymer (A) to be manufactured in any way. It is possible to obtain the acrylic copolymer (A) by making use of a carbon chain of a copolymer (A1) or the like as a principal chain, which is comprised of a (meth)acrylic ester, an unsaturated compound which contains a hydroxyl group, an unsaturated compound which contains a carboxyl group, or the like, and then by performing an addition reaction of a chemical compound (A2), which has a carbon-carbon double bond and has a functional group by which it is possible to perform the addition reaction with a functional group that the copolymer (A1) has.

As the above mentioned (meth)acrylic ester, a hexyl acrylate, an n-octyl acrylate, an isooctyl acrylate, 2-ethylhexyl acrylate, a dodecyl acrylate, a decyl acrylate, or the like, that individually have a carbon number between six and twelve, or a pentyl acrylate, an n-butyl acrylate, an isobutyl acrylate, an ethyl acrylate, a methyl acrylate, or the like, each being a monomer which has a carbon number of less than or equal to five respectively, or a methacrylate, which is equivalent to those, or the like are possible. In this case, the larger the carbon number is, of which a monomer is to be made, the lower the glass transition point becomes for the monomer. Therefore it becomes possible to manufacture a material having a desirable glass transition point. Moreover, in addition to the glass transition point, in order to improve compatibility and performance it is possible to mix in a low molecular weight compound that has a carbon-carbon double bond within a range lower than or equal to five percent by mass, such as a vinyl acetate, a styrene, an acrylonitrile, or the like.

Further, as an unsaturated compound which contains a hydroxyl group, it is possible to give examples such as a 2-hydroxyethyl acrylate, a 2-hydroxyethyl methacrylate, a 2-hydroxypropyl acrylate, a 2-hydroxypropyl methacrylate, or the like.

Moreover, as an unsaturated compound that contains a carboxyl group, it is possible to give examples such as an acrylic acid, a methacrylic acid, or the like,

As the above mentioned functional group in the chemical compound (A2) which has the carbon-carbon double bond and the functional group by which it is possible to perform the addition reaction, in the case where the functional group in the copolymer (A1) is a carboxyl group or a cyclic acid anhydride group it is possible to give examples such as a hydroxyl group, an epoxy radical, an isocyanate group, or the like. In addition, in the case where the same is a hydroxyl group it is possible to give examples such as a cyclic acid anhydride group, an isocyanate group, or the like. Also, in the case where the same is an amino group it is possible to give examples such as an isocyanate group or the like. Moreover, as examples of the chemical compound (A2), an acrylic acid, a methacrylic acid, a cinnamic acid, an itaconic acid, a fumaric acid, a phthalic acid, a sort of 2-hydroxyalkyl acrylate, a sort of 2-hydroxyalkyl methacrylate, a sort of glycol mono acrylate, a sort of glycol mono methacrylate, an N-methylol acrylamide, an N-methylol methacrylamide, an allyl alcohol, a sort of N-alkyl amino ethyl acrylate, a sort of N-alkyl amino ethyl methacrylate, a sort of acrylic amide, a sort of methacrylic amide, a maleic acid anhydride, an itaconic acid anhydride, a fumaric acid anhydride, a phthalic acid anhydride, a glycidyl acrylate, a glycidyl methacrylate, an allyl glycidyl ether, a chemical compound of polyisocyanate in which a part of the isocyanate group is urethanated using a monomer which has a hydroxyl group or a carboxyl group and a carbon-carbon double bond of photo polymeric type, or the like are possible.

As an organic solvent in the case of performing the copolymerization by making use of a solution polymerization for the composition of the above mentioned acrylic copolymer (A), it is possible to make use of a solvent such as a ketone system, an ester system, an alcohol system, an aromatic system, or the like. It is further preferable for the solvent to be made using an acrylic polymer as a good solvent in general which has a boiling point within a range from 60° C. to 120° C., such as a toluene, an ethyl acetate, an isopropyl alcohol, a benzene methyl cellosolve, an ethyl cellosolve, an acetone, a methyl ethyl ketone, or the like. Usually, a polymerization initiator is made of an azobis system, such as an α, α′-azobisisobutyronitrile or the like, and of a radical generating agent, such as a benzoyl peroxide or the like as an organic peroxide system for example. In such a case it is possible to make use of a catalyst and a polymerization inhibitor as required. Moreover, it becomes possible to obtain an acrylic copolymer (A) that has a desired molecular weight by controlling the temperature of polymerization and the period of time of the polymerization, and then thereafter by performing the addition reaction for the functional group. Further, regarding control of the molecular weight, it is desirable to make use of a solvent such as a mercaptan, a carbon tetrachloride system, or the like. Furthermore, this copolymerization is not to be limited to solution polymerization. It is possible for the same to be formed by making use of another method, such as block polymerization, suspension polymerization, or the like.

Thus, it is possible to obtain the acrylic copolymer (A) in such a manner. Moreover, in accordance with the present invention it is desirable for the weight average molecular weight of the acrylic copolymer (A) to be approximately within a range from three hundred thousand to one million. On the contrary, in the case where the molecular weight is less than three hundred thousand, the cohesive force of radiation exposure becomes smaller. Therefore, it becomes easier for a device element to shift during dicing of a wafer. Hence there are cases in which it becomes difficult to perform image recognition. Further, it is further preferable for the molecular weight to be more than or equal to four hundred thousand in order to prevent the device element from shifting as much as possible. It is also not desirable for the molecular weight to be more than one million, because there is a probability of which the same will become gelatinized while performing the composition and the coating. Still further, the glass transition point is lower from the point of view of the properties. Therefore it is not possible to obtain fluidity as sufficiently for the adhesive after performing the radiation exposure in cases where the radiation exposure is performed not as a pattern shape but for whole thereof even if the molecular weight is larger. Hence it is not possible to obtain a sufficient gap between each of the device elements after drawing. Therefore no problems occur such that it becomes difficult to perform image recognition during pick up. However, it is still preferable for the same to be less than or equal to nine hundred thousand. Still further, the molecular weight in accordance with the present invention is defined here to be the weight average molecular weight by a reduction of polystyrene.

Still further, in accordance with the present invention regarding introducing a quantity of the photo polymeric carbon-carbon double bond in the acrylic copolymer (A), it may be available if it is possible to sufficiently obtain an effect of decreasing the adhesive strength by the quantity after performing the radiation cure. It is desirable for the quantity introduced to be within a range from 0.5 meq/g to 2.0 meq/g, or it is further preferable for the quantity introduced to be within a range from 0.8 meq/g to 1.5 meq/g, though it is not univocal as it is different depending on the working conditions or the like of an exposure dose of UV for example. However, in the case where the quantity of the double bonds is excessively large, there may be cases where it is not possible to obtain sufficient fluidity of the adhesive after performing radiation exposure, and therefore it is not possible to obtain a sufficient gap between each of the device elements after drawing, and it becomes difficult to perform image recognition of each of the device elements during pick up. Still further, the acrylic copolymer (A) itself lacks in stability, and thus it becomes difficult to manufacture the same.

Still further, in accordance with the present invention regarding the gel fraction of the adhesive layer (7), it is possible to perform control by making use of the average molecular weight of the acrylic copolymer (A) and the blending quantity of the curing agent. It is desirable for the gel fraction to be sixty percent or greater, and it is further preferable for the gel fraction to be eighty or greater. In the case where the gel fraction is excessively small, it becomes easier for the constituent of the adhesive to be fluidized on an adhesive interface. It becomes harder to obtain temporal stability of the releasing force.

Still further, the acrylic copolymer (A) is designed to comprise a hydroxyl group and a carboxyl group that are individually unreacted and attached to a principal chain. It is desirable if the acrylic copolymer (A) comprises a hydroxyl group which has a hydroxyl value within a range from 0.1 mgKOH/g to 60 mgKOH/g, because it becomes possible to reduce the risk of metallic corrosion of alumina or the like. Still further, it is further preferable for the hydroxyl value to be within a range from 20 mgKOH/g to 56 mgKOH/g. Moreover, in the case where the hydroxyl value is excessively low, it is not possible to obtain a sufficient bridge formation. The probability of glue remaining also becomes higher. Furthermore, in the case where the hydroxyl value is excessively high, the probability of metallic corrosion of alumina or the like becomes higher. Still further, in the case where the acrylic copolymer (A) comprises a carboxyl group which has an acid value within the range from 0.5 mgKOH/g to 10 mgKOH/g, it becomes possible to reduce the risk of metallic corrosion of pure copper, copper oxide or the like. It is further preferable for the acid value to be within a range from 1.0 mgKOH/g to 7.0 mgKOH/g. Still further, the lower the hydroxyl value and the acid value is, the less corrosion there is. However, the copolymer loses desirable properties as a adhesive. Moreover, those functional groups individually have a positive effect on corrosion prevention even before being taken into the cross linking system due to the, curing agent, or even after being taken therein.

Furthermore, in the case where the polymer is made for the process of a device or the like to which alumina is applied, and in the case where the antistatic performance is not particularly required, it is not necessary to provide the antistatic layer (5). It is possible to solve the problem of corrosion of alumina in the case where a copolymer of an acrylic system is designed to be the principal ingredient of a group which contains at least a radiation curable carbon-carbon double bond containing group, a hydroxyl group and a carbonyl group, that are individually attached to a principal chain, and if each of the materials is within the above mentioned range respectively.

Still further, in the case where the radiation curable adhesive layer (7) made for the present invention is cured by performing ultraviolet irradiation, it is possible to make use of a photo polymerization initiator as a subsidiary ingredient in response to a requirement, such as an isopropyl benzoin ether, an isobutyl benzoin ether, a benzophenone, a Michler's ketone, a chloro thioxanthone, a dodecyl thioxanthone, a dimethyl thioxanthone, a diethyl thioxanthone, a benzyl dimethylketol, an α-hydroxycyclohexyl phenyl ketone, a 2-hydroxymethyl phenyl propane, or the like. Still further, it is desirable for the blending quantity of each of those photo polymerization initiators to be within a range from 0.01 parts by mass and 5 parts by mass corresponding to 100 parts by mass of the acrylic polymer, respectively.

Still further, it is possible for the radiation curable adhesive layer (7) to contain a curing agent such as a polyisocyanate compound or the like as a subsidiary ingredient in response to the requirement. It is desirable for the blending quantity of the curing agent to be within a range from 0.5 parts by mass to 10 parts by mass corresponding to one hundred parts by mass of the acrylic polymer that is the principal ingredient.

Still further, it is desirable for a thickness of the adhesive layer (7) to be within a range from 1.0 μm to 70 μm. The reason is that it is not possible to hold a workpiece in a case where the thickness of the adhesive layer (7) is excessively thin, as well as the antistatic performance becomes worse in the case where the same is excessively thick. It is further preferable for the thickness of the above mentioned adhesive to be within a range from 5.0 μm to 30 μm. Or, it is desirable at the most for the same to be within a range from 5.0 μm to 20 μm.

Furthermore, the release liner (9) is made of a polyethylene terephthalate film or the like, which is finished by silicone mold release treatment.

Here, in accordance with the present embodiment it becomes possible to use a metal, such as pure copper or the like, and alumina. And hence it becomes possible to prevent corrosion of the magnetic head of GMR type, which is stringent against corrosion, from occurring.

Moreover, in accordance with the present embodiment it becomes possible to obtain extremely high antistatic performance.

Further, in accordance with the present embodiment it becomes possible to obtain superior adherence between the antistatic layer and the adhesive.

Still further, in accordance with the present embodiment it becomes possible to remove the adherend more easily, because the radiation curable adhesive is made for the adhesive layer.

Moreover, in accordance with the present embodiment it becomes possible to perform dicing or back grinding treatment or the like of the semiconductor component with less negative effect to the surface of the adherend. Hence it becomes possible to make use of the same in a wider range of fields. Furthermore, it becomes possible to make use of the same with the effect of preventing a decrease in the production yield rate of the electronic components (such as the hard disk or the like) and the semiconductor product.

### EXAMPLES

The present invention will be described in further detail below based on the Examples. The Examples of the performance test will be shown with Comparative examples, thereby showing the superior advantages in accordance with the present invention. However, the present invention is not limited to any of those examples.

Moreover, the term percent hereinafter designates a percent by mass.

In accordance with each of the present Examples and with each of the Comparative examples three types of the adhesives α1, α2 and β1 are made for the adhesive layer in the adhesive tape. Each of those will be described in detail below.

The adhesive α1 is a copolymer of an acrylic system, each having a radiation curable carbon-carbon double bond containing group, a hydroxyl group and a carbonyl group, respectively. Moreover, the same has a hydroxyl value of 34 mgKOH/g, an acid value of 6.6 mgKOH/g, and the quantity of the carbon double bond is 0.9 meq/g. A coating solution for the adhesive is prepared by mixing a curing agent with a proportion of one part and a photo polymerization initiator with five parts into one hundred parts of the adhesive α1. The adhesive tape is then manufactured by coating a desired thickness of the prepared coating solution for the adhesive on to a polyethylene terephthalate film, and then by sticking together with a base material film.

The adhesive α2 is a copolymer of an acrylic system, each having a radiation curable carbon-carbon double bond containing group, a hydroxyl group and a carbonyl group, which is similar to α1. In addition, the same has a hydroxyl value of 56 mgKOH/g, an acid value of 0.7 mgKOH/g, and the quantity of the carbon double bond is 0.6 meq/g. A coating solution for the adhesive is prepared by mixing a curing agent with a proportion of one part and a photo polymerization initiator with five parts into one hundred parts of the adhesive α2. Then, the adhesive tape is manufactured by coating similar to that in the adhesive α1.

Moreover, the adhesive β1 is an acrylic ester that does not contain a radiation curable carbon-carbon double bond containing group to be attached to a principal chain. A coating solution for the adhesive is prepared by mixing with a proportion of one hundred parts of the adhesive β1, one hundred and fifty parts of an oligoester acrylate, 4.2 parts of a curing agent and five parts of a photo polymerization initiator. Then, the adhesive tape is manufactured by coating, which is similar to that in the adhesive α1.

### Example 1

A polyolefin film is made as a base material, which has a thickness of approximately one hundred micrometers. Then, an antistatic layer is formed by forming a polymer layer of a polypyrrole system on to both faces of this base material using the immersion polymerization method such that the thickness of each is 0.05 micrometers.

Moreover, the coating solution of the adhesive is prepared by mixing the photo polymerization initiator and the curing agent into the adhesive α1. Further, coating is performed by making use of a comma coater with a line speed of two meters per minute using the coating solution for the adhesive which is prepared as a polyethylene terephthalate film (with having a thickness of twenty-five micrometers) after performing a silicone mold release treatment. The same is then stuck together with the base material film by passing the same through a warm air drying furnace that is set up at a temperature of 110° C. Hence the adhesive tape for electronic component fabrication is manufactured, having a coating thickness of ten micrometers after the drying, and having a release liner.

### Example 2

An antistatic layer is formed, which is similar to that in accordance with Example 1. The photo polymerization initiator and the curing agent are mixed with the adhesive α2. A adhesive tape for electronic component fabrication is manufactured by making use of a process which is similar to that in accordance with Example 1, such that the adhesive layer has a coating thickness of ten micrometers after drying, and has a release liner.

### Example 3

An antistatic layer is formed, which is similar to that in accordance with Example 1. The photo polymerization initiator and the curing agent are mixed with the adhesive α1. A adhesive tape for electronic component fabrication is manufactured by making use of a process which is similar to that in accordance with Example 1, such that the adhesive layer has a coating thickness of thirty micrometers after drying, and has a release liner.

### Example 3

Coating is performed by making use of a gravure coater that coats an electrically conductive polymer of a polythiophene system having a layer thickness of 0.5 micrometer on to the polyolefin film having a thickness of approximately one hundred micrometers, and hence the antistatic layer is formed. The photo polymerization initiator and the curing agent are mixed with the adhesive α1. The adhesive tape for electronic component fabrication is manufactured by making use of a process which is similar to that in accordance with Example 1, such that the adhesive layer has a coating thickness of thirty micrometers after drying, and has a release liner.

### Comparative Example 1

An antistatic layer is formed, which is similar to that in accordance with the Example 1. Then, an oligomer, the photo polymerization initiator and the curing agent are mixed with the adhesive β1. A adhesive tape for electronic component fabrication is manufactured by making use of a process which is similar to that in accordance with Example 1 such that the adhesive layer has a coating thickness of thirty micrometers after drying, and has a release liner.

### Comparative Example 2

A coating is performed by making use of the gravure coater using a surface active agent of a quaternary ammonium salt system to form a layer thickness of 1.0 micrometer on to a polyolefin film that has a thickness of approximately one hundred micrometers, and hence an antistatic layer is formed. Then the oligomer, the photo polymerization initiator and the curing agent are mixed with the adhesive β1. A adhesive tape for electronic component fabrication is manufactured by making use of a process which is similar to that in accordance with Example 1, such that the adhesive layer has a coating thickness of thirty micrometers after drying, and has a release liner.

### Comparative Example 3

A coating is performed by making use of the gravure coater using the surface active agent of the quaternary ammonium salt system to form a layer thickness of 1.0 micrometer on to the polyolefin film that has a thickness of approximately one hundred micrometers, and hence the antistatic layer is formed. Then the photo polymerization initiator and the curing agent are mixed with the adhesive α2. A adhesive tape for electronic component fabrication is manufactured by making use of a process which is similar to that in accordance with Example 1 such that the adhesive layer has a coating thickness of thirty micrometers after drying, and has a release liner.

### Comparative Example 4

A coating is performed by making use of the gravure coater using an antistatic agent of a complex system of boron and nitrogen to form a layer thickness of 5.0 micrometer on to the polyolefin film that has a thickness of approximately one hundred micrometers, and hence an antistatic layer is formed. The photo polymerization initiator and the curing agent are mixed with the adhesive β1. A adhesive tape for electronic component fabrication is manufactured by making use of a process which is similar to that in accordance with Example 1 such that the adhesive layer has a coating thickness of thirty micrometers after drying, and has a release liner.

### (Measurement of the Acid Value and Hydroxyl Value of the Adhesive)

A measurement of the acid value and hydroxyl value is performed on the adhesive of the adhesive tape that is obtained by making use of the above mentioned processes.

The measurement of the acid value is performed according to JIS K 5407 11.1.

(a) Chemical Reagent:
Bromothymol Blue indicator,
a solution of 0.01N potassium hydroxide and ethanol, and
an extra pure acetone chemical reagent.

(b) Operation

A sample of approximately ten grams is to weighed and taken into a conical flask precisely, then the same is dissolved into fifty milliliters of an acetone, and then thereafter three or four drops of the Bromothymol Blue indicator is added therein. Moreover, titration is performed for this solution by making use of the solution of 0.01N potassium hydroxide and ethanol.

(c) Calculation

The acid value is calculated using the following formula.

Acid value=56.11Vf/100S (Formula 1)

V: a titer (ml) of the solution of 0.01N potassium hydroxide and ethanol;

f: a factor of the solution of 0.01N potassium hydroxide and ethanol; and

S: a collection quantity of the sample.

The measurement of the hydroxyl value is performed according to JIS K 0070.

(a) Chemical Reagent:
an acetylated chemical reagent (acetic anhydride pyridine), and
a solution of N/2 potassium hydroxide and ethanol.

(b) Operation

A sample is acetylated using the acetylated chemical reagent. Then titration is performed for the excessive acetic acid using the solution of N/2 potassium hydroxide and ethanol.

(c) Calculation

The hydroxyl value is calculated using the following formula.

Hydroxyl value=28.05(VB−V)F/S+AV (Formula 2)

V: a titer (ml) of the solution of N/2 potassium hydroxide and ethanol of the real test;

VB: a titer (ml) of the solution of N/2 potassium hydroxide and ethanol of the blank test;

F: a factor of the solution of N/2 potassium hydroxide and ethanol;

S: a collection quantity (g) of the sample; and

AV: an acid value (mgKOH/g) of the sample.

(Performance Test of the Adhesive Tape for Electronic Component Fabrication)

Regarding the adhesive tape which is obtained by making use of the above mentioned processes the following measurements are performed; (1) surface specific resistance; (2) adherence between the antistatic layer and the adhesive layer; (3) confirmation of the corrosion by a dip test; and (4) ionic adulterant dosage.

(1) Surface Specific Resistance

The measurement is performed according to JIS K6911 and using a measuring instrument for surface specific resistance (the R-8740 which is produced by ADVANTEST CORPORATION).

(2) Adherence between the Antistatic Layer and the Adhesive Layer

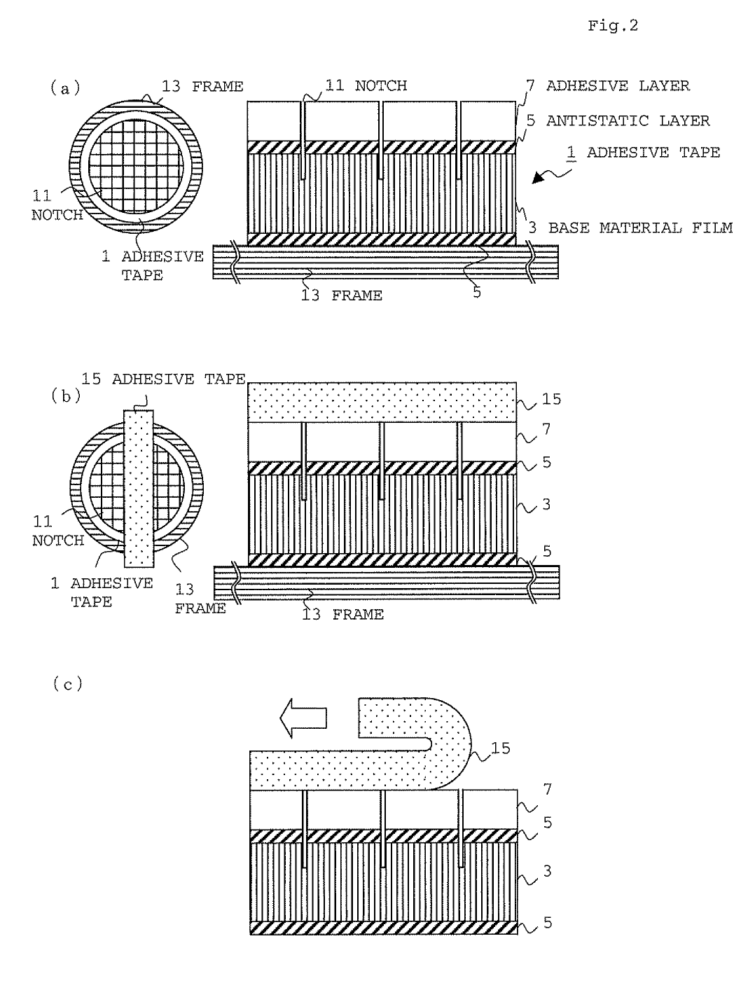

The method of the adherence test will be described in detail below using FIG. 2. In the first instance, adhesive tape (1) is stuck to the inner side of a frame (13), and then notches are made to have the shape of a checkerboard pattern from the surface to a depth of ten micrometers plus the thickness of the adhesive layer (7) by making use of a dicer, as shown in FIG. 2 (a). Moreover, the size of each of checkerboard pattern is set up to be 1 cm by 1 cm respectively. After completely drying the sample, a adhesive tape (15), which has an adhesive strength of approximately 20 Newton per 25 mm, is stuck together with the sample using a 2 kg sticking roller, as shown in FIG. 2 (b). Then, UV irradiation is performed, after which the sample is left as is for one hour. Further, the exposure dose is set to be 500 mJ/m² in accordance with this experiment.

Thereafter the sample is cut to have the dimensions of which the width is 25 mm and a length is 10 cm, in which the adhesive tape (15) and the adhesive tape (1) are stuck together. The adhesive tape (15) is torn off from the adhesive tape (1) with an angle of 180 degrees and a speed of 1000 mm per minute, as shown in FIG. 2 (c). An evaluation is performed regarding the omission of the adhesive layer (7) from the antistatic layer (5) by counting the number of the adhesive layers (7) that are released from the adhesive tape (1) to the adhesive tape (15). Here, a sample is defined to be zero percent when there is no omission at all, and on the contrary, a sample is defined to be one hundred percent when there is omission of all the pieces.

(3) Confirmation of the Corrosion by the Dip Test

A sampling is performed using approximately one gram of the adhesive tape as a sample, and then the release liner is to be torn off. The sample from which the release liner is torn off is immersed into a vessel in which fifty milliliters of pure water is added with a magnetic head which is comprised of copper, alumina and a nickel alloy. Thereafter the magnetic head is taken out from the solution after heating at 60° C. for one hour. The corrosion of the magnetic head is confirmed using a field emission type scanning electron microscope (FE-SEM). Here, the number of magnetic heads for the confirmation is thirty pieces for each. The number is shown in the following Table 1, of which the magnetic head becomes to have corrosion among the thirty pieces.

(4) Measurement of the Ionic Adulterant Dosage by an Ion Chromatography Test

After sampling the film using approximately one gram as a sample, fifty milliliters of pure water is added therein, and the same is then heated up to 100° C. Measurement is performed using an ion chromatograph DX-120 (which is produced by NIPPON DIONEX KK) for the ionic adulterant dosage that is contained in the extracted solution.

(Experimental Result)

The result of each of the Examples and of each of the Comparative examples is shown together in the Table 1.

In the first instance, regarding the adherence between the antistatic layer and the adhesive layer, approximately fifty percent cannot help but become torn off in accordance with the Comparative example 2 and the 3, because each of the antistatic agents is not the electrically conductive polymer, respectively. On the contrary, in accordance with the Examples from 1 to 4 and the Comparative example 1 it was not possible to find any peeling at all, for each electrically conductive polymer is used, respectively. However, in accordance with the Comparative example 1 for which the process of the polymerization of the adhesive is different from that in accordance with each of the Examples, it is found that corrosion occurred on the magnetic head.

Regarding the surface specific resistance which is one of the indicators for the antistatic performance, in performing a comparison between the Example 1 and the Example 3, the value of the surface specific resistance in accordance with the Example 1 was lower when the thickness of the adhesive was thinner. Moreover, the thinner the thickness of the adhesive is, the more superior the result of the value becomes after performing the UV irradiation.

Regarding the corrosion test, in accordance with each of the Examples from 1 to 4 the result was obtained in which it was not possible to find any corrosion at all, or was seldom found. On the contrary, in accordance with each of the Comparative examples from 1 to 4 the result is obtained in which a plurality of the magnetic heads cannot help but have corrosion.

Thus, in accordance with each of the Examples from 1 to 4 it is preferred that it be possible to obtain superior adherence and that the same will not cause corrosion of the magnetic head to occur at all. Moreover, it is further preferred in accordance with the Example 1, that it be possible to obtain superior adherence and that the same will not cause corrosion of the magnetic head to occur at all, and that it be possible to obtain a lower surface specific resistance value.

TABLE 1

| | | | | | Comparative | Comparative | Comparative | Comparative |
|---|---|---|---|---|---|---|---|---|
| | Example 1 | Example 2 | Example 3 | Example 4 | example 1 | example 2 | example 3 | example 4 |
| Antistatic | Polypyrrole | Polypyrrole | Polypyrrole | Polythiophene | Polypyrrole | Surface active | Surface active | Antistatic |
| layer | system | system | system | system | system | agent of a | agent of a | agent of a |
| | polymer | polymer | polymer | polymer | polymer | quaternary | quaternary | complex |
| | | | | | | ammonium salt | ammonium salt | system of |
| | | | | | | system | system | boron and |
| | | | | | | | | nitrogen |
| Formation | Immersion | Immersion | Immersion | Gravure | Immersion | Gravure | Gravure | Gravure |
| method | polymerization | polymerization | polymerization | coating | polymerization | coating | coating | coating |
| Type of | α1 | α2 | α1 | α1 | β1 | β1 | α2 | β1 |
| adhesive | | | | | | | | |
| Thickness of | 10 | 10 | 30 | 10 | 30 | 30 | 10 | 30 |
| adhesive [μm] | | | | | | | | |
| Hydroxyl value | 34 | 56 | 34 | 34 | — | — | 56 | — |
| (mgKOH/g) | | | | | | | | |
| Acid value | 6.6 | 0.7 | 6.6 | 6.6 | — | — | 0.7 | — |
| (mgKOH/g) | | | | | | | | |
| Quantity of the | 0.9 | 0.59 | 0.9 | 0.9 | — | — | 0.59 | — |
| carbon double | | | | | | | | |
| bond (meq/g) | | | | | | | | |
| Surface specific | 10⁷ | 10⁷ | 10⁹ | 10⁹ | 10⁹ | 10⁹ | 10⁹ | 10⁹ |
| resistance before | | | | | | | | |
| performing the | | | | | | | | |
| UV irradiation | | | | | | | | |
| (Ω/□) | | | | | | | | |
| Surface specific | 10⁷ | 10⁸ | 10¹² | 10¹¹ | 10¹¹ | 10¹¹ | 10¹¹ | 10¹⁰ |
| resistance after | | | | | | | | |
| performing the | | | | | | | | |
| UV irradiation | | | | | | | | |
| (Ω/□) | | | | | | | | |
| Corrosion | 0 | 1 | 0 | 0 | 20 | 30 | 14 | 30 |
| (pieces) | | | | | | | | |
| Delamination | 0 | 0 | 0 | 0 | 0 | 60 | 40 | 80 |
| rate (%) | | | | | | | | |
| Chloride ion | <0.05 | <0.05 | <0.05 | <0.05 | <0.05 | <0.05 | <0.05 | 18.53 |
| content (ppm) | | | | | | | | |
| Fluorine ion | <0.001 | <0.001 | <0.001 | <0.001 | <0.001 | <0.001 | <0.001 | <0.001 |
| content (ppm) | | | | | | | | |

Here, for each of the Examples and for each of the Comparative examples that are shown in the Table, each of the polymers used has a gel fraction that is higher than or equal to eighty percent. However, in the case where the polymer has a gel fraction lower than sixty percent, the result is obtained in which it is not possible to obtain sufficient holding power, and hence the chip is shifted during the dicing process.

Thus, the preferred embodiment has been described in detail regarding the adhesive tape in accordance with the present invention with reference to the attached drawings. However, the present invention is not to be limited to the examples. It is obvious that for those skilled in the art it is possible to reach various kinds of modified examples or corrected examples within the scope of the technological idea which is disclosed in the present application, and it is understood that such also belongs to the technological scope of the present invention as a matter of course.

1. A adhesive tape for electronic component fabrication in order to stick and mount an electronic component which contains metal or alumina, comprising:
a base material; and
a adhesive layer that is formed on one side of said base material,
wherein said adhesive layer has a copolymer of an acrylic system as a principal ingredient, each containing at least a radiation curable carbon-carbon double bond containing group, a hydroxyl group and a carbonyl group, that are individually attached to a principal chain, a proportion of said radiation curable carbon-carbon double bond containing group on said principal chain in said copolymer of an acrylic system is within a range from 0.5 to 2.0 meq/g, a proportion of said hydroxyl group on said principal chain in said copolymer of an acrylic system is within a range from 0.1 to 60 mgKOH/g,
a proportion of said carbonyl group on said principal chain in said copolymer of an acrylic system is within a range from 0.5 to 10 mgKOH/g, and
a gel fraction of said copolymer of an acrylic system is higher than or equal to sixty percent.

2. The adhesive tape for electronic component fabrication according to claim 1,
wherein said base material has an antistatic layer that is formed on both sides or one side thereof.

3. The adhesive tape for electronic component fabrication according to claim 2,
wherein said antistatic layer is formed using an electrically conductive polymer as a polymer of a pi-electron conjugated system.

4. The adhesive tape for electronic component fabrication according to claim 3,
wherein said electrically conductive polymer is a polymer of a polypyrrole system.

5. The adhesive tape for electronic component fabrication according to claim 3,
wherein said electrically conductive polymer is a polymer of a polythiophene system.

6. The adhesive tape for electronic component fabrication according to claim 4,
wherein the thickness of said antistatic layer is within a range from 0.001 to 2.0 μm.

7. The adhesive tape for electronic component fabrication according to claim 6,
wherein the thickness of said adhesive layer is within a range from 1 to 70 μm.

8. The adhesive tape for electronic component fabrication according to claim 5,
wherein the thickness of said antistatic layer is within a range from 0.001 to 2.0 μm.

9. The adhesive tape for electronic component fabrication according to claim 8,
wherein the thickness of said adhesive layer is within a range from 1 to 70 μm.
